(19) United States
(12) Patent Application Publication
(10) Pub. No.: US 2012/0283997 A1
(43) Pub. Date: Nov. 8, 2012

(54) DEVICE FOR SIMULATING AN ENVIRONMENT OF AN INFRASTRUCTURE SUPERVISION SYSTEM

(75) Inventors: Olivier Flous, Paris (FR); Alexander Benjamin Doyle, Brighton (GB); Mehul Rajendrabhai Patel, Crawley (GB)

(73) Assignee: THALES, NEUILLY SUR SEINE (FR)

(21) Appl. No.: 13/375,959

(22) PCT Filed: Jun. 2, 2010
(86) PCT No.: PCT/EP10/57695

§ 371 Date: Jul. 25, 2012

(30) Foreign Application Priority Data
Jun. 5, 2009 (FR) 0902728

(51) Int. Cl. G06F 17/50

(52) U.S. Cl. 703/1

(57) ABSTRACT

A device for simulating an environment of an infrastructure supervision system generating a three-dimensional representation of the infrastructure using real data from real equipment supervised by the supervision system complemented with simulated data from simulation models that make up the simulation device. The device is suitable for use in supervised infrastructures such as transport networks, factories, and public infrastructures.

The present invention relates to a device for simulating an environment of an infrastructure supervision system generating a representation of a situation in three dimensions of the infrastructure. The supervised infrastructure may be a transport network, a factory, a public infrastructure.

Infrastructure supervision systems use many video surveillance cameras. The video surveillance cameras enable an operator of the supervision system to have an overview of the installations that have to be managed. Each camera has a corresponding view which can be displayed on a screen or a portion of screen. These multiple views make it possible, for example, for a supervision operator to quickly detect an anomaly which has not yet been flagged by the supervision system equipment.

Equipping infrastructures with video surveillance cameras is very costly, notably with regard to the processing of the data collected.

Furthermore, the situation picked up by the cameras is shown by images in two dimensions. However, images in two dimensions are difficult to interpret, except by personnel qualified in the use of the supervision system. In an emergency situation, it is necessary for people who have no knowledge of the infrastructure to be able to have an overview of the state of the situation in order to act in the infrastructure. With the current tools for displaying the images supplied by the video surveillance cameras, it is impossible for a person who is not perfectly familiar with the infrastructure to understand the information represented. For example, it is difficult to follow the movement of a person in the premises, by passing from the view filmed by one camera to another view, filmed by another camera.

For example, in case of fire in the infrastructure, the firefighters need to have reliable and accurate information on the occupancy of the premises by people, and on the positions of the fire centers. The images originating from the video surveillance cameras do not provide such data. In practice, in the case of a fire, the smoke or the heat can make the video surveillance camera inoperative. Furthermore, since the firefighters are not familiar with the premises, they can not simply and rapidly assess the situation on the basis of the screens presenting the situation filmed by the video surveillance cameras.

One aim of the invention is notably to provide means for displaying a situation in three dimensions. To this end, the subject of the invention is a device for simulating an environment of an infrastructure supervision system. The supervision system notably comprises one or more applications for supervising real equipment of the infrastructure, a common supervision infrastructure to which the supervision applications are connected. The simulation device comprises a model for generating representations in three dimensions of a situation in the infrastructure on the basis of real data. The real data originate from real equipment supervised by the supervision system, via an interface between the common supervision infrastructure and the simulation device. The real data are complemented with virtual data originating from simulation models. The virtual data being deduced by the simulation models from the real data originating directly from the common supervision infrastructure. The virtual data model description data concerning the situation in the infrastructure, not transmitted by the supervised real equipment.

The simulation device notably comprises first models simulating equipment of the infrastructure. The first models, in an advantageous embodiment of the invention, may have an operation in real mode during which the data originating from the real equipment are transformed into simulated data then broadcast to the other simulation models via a synthetic environment infrastructure.

The first equipment simulation models may comprise an equipment simulation engine generating simulated data. According to an advantageous embodiment of the invention, the simulation engine is inactive in real mode.

The simulation device may comprise second simulation models, simulating virtual entities. The second models may have an operation in real mode during which they interpret the real data received to model virtual entities.

The model for generating representations in three dimensions may generate images in three dimensions notably on the basis of data of a description model of the infrastructure in three dimensions and data originating from the real equipment broadcast via the synthetic environment infrastructure.

The description model of the infrastructure in three dimensions may be updated on the basis of the data originating from the real equipment, that it recovers via the synthetic environment infrastructure.

In an advantageous embodiment of the invention, a behavioral model may simulate people occupying the infrastructure. The behavioral model may interpret the real data to deduce therefrom the number and the positions of the people occupying the infrastructure, the virtual data corresponding to the simulated people being broadcast via the synthetic environment infrastructure.

In an advantageous embodiment, the model for generating representations in three dimensions may generate images in three dimensions comprising the people simulated by the behavioral model.

The main advantages of the invention are notably that it is simple to use and enables any user to have a global and synthetic view of a situation in a supervised infrastructure.

Other features and advantages of the invention will become apparent from the following description, given as a non-limiting illustration, and in light of the appended drawings which represent:

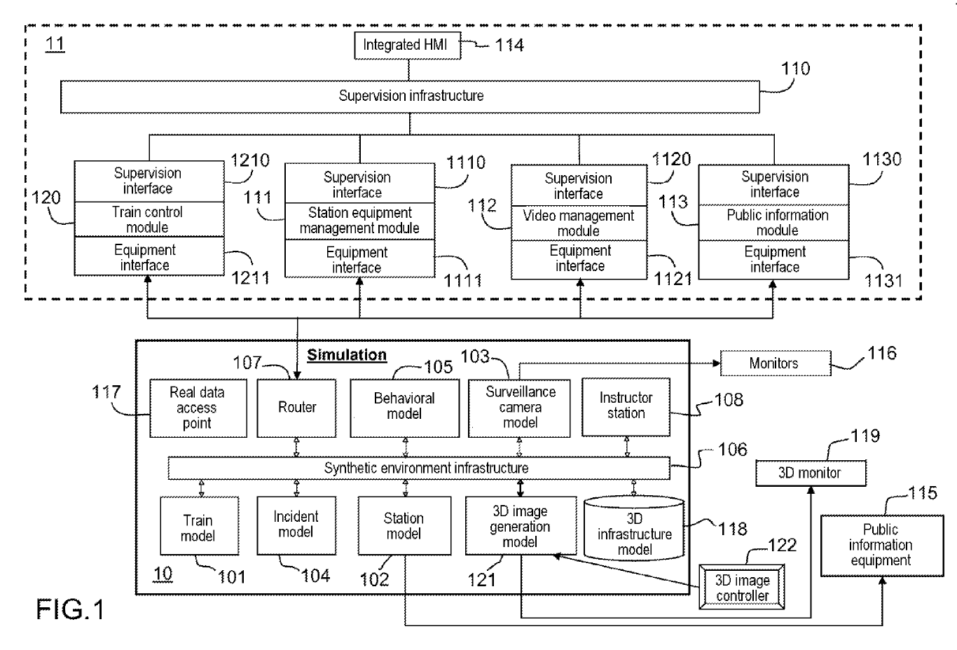

FIG. 1: schematically, an architecture of a supervision system simulation environment according to the invention;

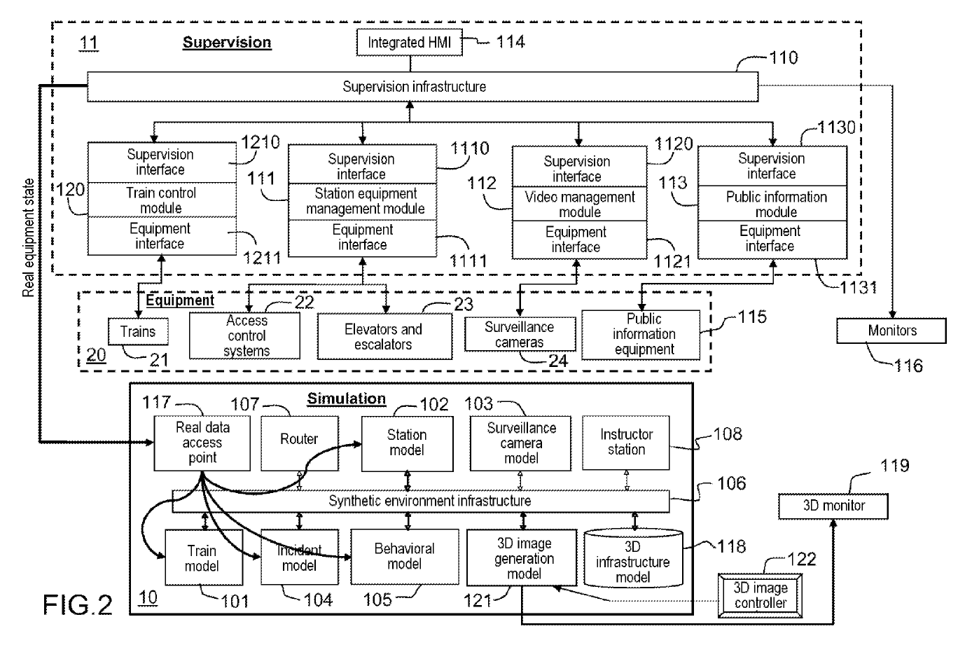

FIG. 2: schematically, the architecture of the supervision system simulation environment according to the invention operating with real data;

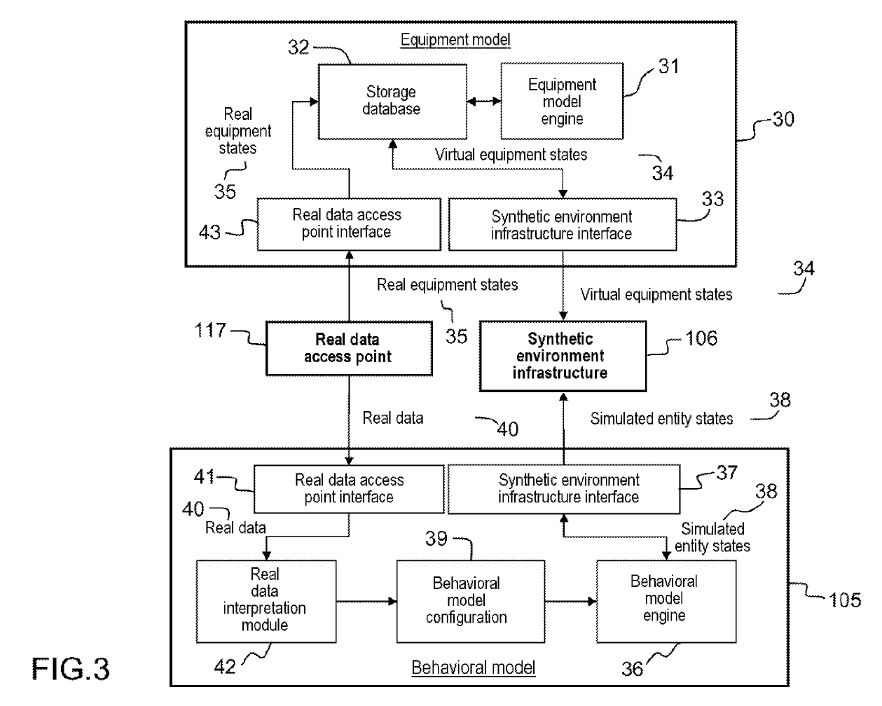

FIG. 3: an example of an architecture of a simulation model and of a behavioral model;

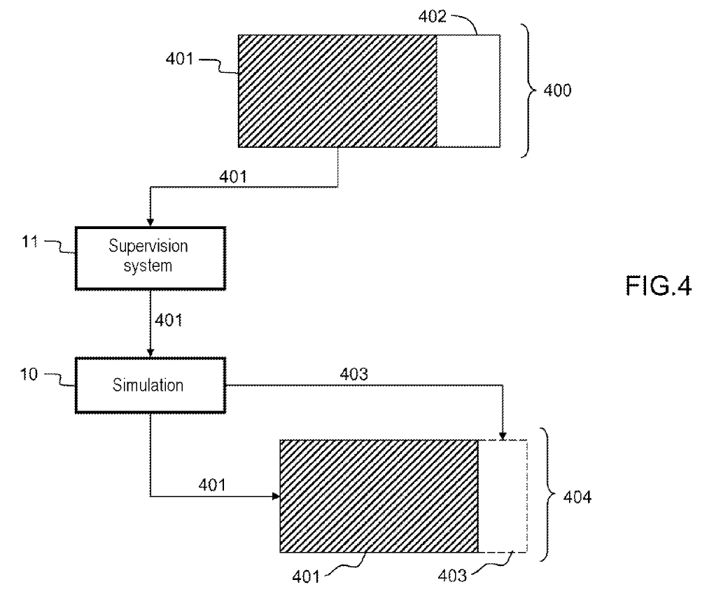

FIG. 4: a general block diagram of the invention.

FIG. 1 represents an exemplary architecture of a simulation environment 10 according to the invention of a supervision system 11. The supervision system 11 represented in FIG. 1, by way of example, is a supervision system for an overland transport network 11, such as a train network for example.

The simulation environment 10 can notably be used to train supervision operators in the use of the supervision system 11 by simulating real situations. To this end, the simulation environment models an environment of the supervision system and notably the data that it expects therefrom. For example, the simulation environment can model equipment of the overland transport network and communicate the states thereof to the supervision system as if they originated from real equipment.

The supervision system 11 comprises a supervision software infrastructure 110, more commonly called supervision framework 110. The supervision framework 110 notably allows different applications to exchange data simply and uniformly.

A supervision system may comprise a number of supervision functions. For example, the supervision system of an overland transport network 11 represented in FIG. 1 comprises four supervision functions for different equipment of the overland transport network infrastructure. Each supervision function is fulfilled by an independent software application 120, 111, 112, 113 in the example represented in FIG. 1. Each software application 120, 111, 112, 113 comprises:

a first supervision interface 1210, 1110, 1120, 1130;

a second interface 1211, 1111, 1121, 1131 with equipment that it supervises.

The supervision framework 110 makes it possible to orchestrate different supervision services provided by the supervision applications 120, 111, 112, 113. The supervision framework 110 defines a context for the data exchanges between the supervision applications 120, 111, 112, 113 and the supervision framework 110 itself. For example, the supervision framework defines standard data exchange interfaces.

A first supervision application 120 is, for example, a train control module 120. The train control module 120 is used to handle the supervision of the trains. For example, the train control module 120 makes it possible to: know the position of each train on the overland transport network, transmit service messages to the train drivers.

A second supervision application 111 is, for example, an equipment management module 111 for a station of the overland transport network. The equipment management module 111 makes it possible to supervise equipment of a station such as escalators, automatic gates, elevators, fire detectors, access control systems.

A third supervision application 112 may be a video management module 112. The video management module 112 makes it possible to supervise the video systems such as video surveillance cameras, screens for displaying images from the video surveillance cameras.

A fourth supervision application 113 may be a public information module 113. The public information module 113 makes it possible to manage the equipment communicating information to the users of the overland transport network. The communication equipment managed may be message display screens, loudspeakers broadcasting audio messages.

The supervision system may be controlled by one or more operators via an integrated human-machine interface, or HMI, 114. The integrated HMI 114 notably enables one or more operators to drive one or more surveillance applications 120, 111, 112, 113. The integrated HMI 114 also enables the operators to view the states of the supervised equipment. The supervised equipment states are transmitted to the supervision framework 111 by the various supervision applications 120, 111, 112, 113. The supervision framework 110 then formats the equipment states in order to display them on the integrated HMI 114.

The architecture of a simulation according to the invention 10 may comprise a number of models 101, 102, 103, 104, 105, 118, 121. In the example represented in FIG. 1, the simulation architecture comprises seven models. A simulation architecture of a supervision system may comprise models other than those represented in FIG. 1. The simulation architecture 10 according to the invention also comprises a synthetic environment infrastructure 106. The synthetic environment infrastructure 106 is an infrastructure hosting the models 101, 102, 103, 104, 105, 118, 121. The synthetic environment infrastructure 106 notably defines a context for exchanging data between the different models. The synthetic environment infrastructure 106 comprises libraries of interfaces enabling the different models 101, 102, 103, 104, 105, 118, 121 to exchange data in a standardized manner with the synthetic environment infrastructure 106. Each model can simulate one or more entities which may notably be, depending on the models, equipment, trains, users of the transport network. Each model notably transmits the states of the entities that it simulates to the synthetic infrastructure 106. The synthetic environment infrastructure 106 provides the other simulation models 101, 102, 103, 104, 105, 118, 121 with the states of the entities that it has received. Each model can thus recover from the synthetic environment infrastructure 106 the data necessary to its operation. Such a synthetic environment infrastructure 106 may, for example, be implemented according to a DIS (distributed interactive simulation) standard.

The simulation architecture 10 represented in FIG. 1 also comprises a router 107. The router 107 is used on the one hand to transmit to each supervision application 120, 111, 112, 113 the virtual states of the equipment that it supervises. The virtual states of the equipment are supplied by the simulation models 101, 102, 103, 104, 105, 118, 121 to the synthetic environment infrastructure 106. The virtual states transmitted correspond to the states that would be sent by real equipment. The router 107 recovers the states of the equipment to transmit them to the appropriate simulation application 120, 111, 112, 113 via the equipment interface 1211, 1111, 1121, 1131 of each supervision application 120, 111, 112, 113. Also, since each application can drive equipment, commands transmitted to the equipment pass through the router 107 to be transmitted to the simulated equipment models for example.

A first model 101 may be a train model 101. The train model 101 simulates the movements of one or more trains on the transport network. The train model 101 notably simulates the arrival of the train in the different stations of the transport network. To this end, the train model 101 can notably generate the positions of the different trains and their speed for example.

A second model 102 may be a station model of the transport network. The station model 102 may notably simulate different equipment of a station of the transport network. For example, the station model 102 may generate the following data: elevator states, entry door states, state of the electrical power supply on the tracks, state of smoke detectors, state of unauthorized intrusion detectors in a protected space. The station model 102 may transmit to public information equipment 115 information from the public information module 113 of the supervision system 11. For example, the station model 102 may be used to display on a screen information intended for the passengers from the public information application 113. The station model 102 may also transmit audio messages intended for the users of the transport network to loudspeakers.

A third model 103 may be a video surveillance camera model 103. The video surveillance camera model 103 may generate images, in the form of a video stream, intended to be displayed on monitors 116, or display screens. The monitors 116 enable the operators, in a real situation, to view one or more images supplied by one or more video surveillance cameras. The video surveillance camera model generates a synthetic image of the situation as it should be seen by the video surveillance cameras. The video surveillance camera model generates a synthetic image from information supplied by the other models 101, 102, 104, 118, notably including the states of the equipment. To generate images of the infrastructure, the video surveillance camera model 103 uses the data from a three-dimensional, or 3D, infrastructure model 118. The 3D infrastructure model 118 makes it possible to represent, for example, all the infrastructures of a train station: the elevators, escalators, platforms, doors, staircases, corridors, and the station equipment. The states of the equipment supplied by the different models make it possible to animate the images by modeling, for example, a video screen representing a train entering into the station.

A fourth model 104 may be an incident model 104 that makes it possible to simulate events to which a supervision operator must react. The incident model makes it possible notably to simulate a fire in a train station, a bomb explosion, the spread of a cloud of toxic fumes. The incident model can be driven from an instructor station 108 by an instructor organizing a simulation session. From the instructor station 108, an instructor can, for example, choose a type of incident, an incident location, a date for triggering the incident, an incident duration. Depending on the parameters entered by the instructor, the incident model 104 will trigger, during its simulation, the desired incident, on the desired date, in the desired place and for the desired duration.

A fifth model 105 may be a behavioral model 105 making it possible to simulate the behavior of a number of people located in the supervised infrastructure. The model 105 notably makes it possible to model the users of the transport network. The behavioral model 105 is based on a motivational model in which each simulated individual moves on the basis of his or her own motivations. It is possible to drive a simulated individual by the behavioral model 105 from the instructor station 108. For example, it may be possible to order an individual to move in a given direction. The simulated individuals can be moved around in the infrastructure of the transport station.

A sixth model 121 is a model for generating a three-dimensional, or 3D, image 121. The model for generating a 3D image makes it possible to generate an image in three dimensions of the infrastructure based notably on the data for the infrastructure model, and data from the other models such as the positions of the individuals in the infrastructure, the positions of the trains, the states of the escalators. Thus, a three-dimensional view of the situation can be represented to an operator of the supervision system on a 3D monitor 119. The operator can move around in this three-dimensional view via a suitable interface: a 3D image controller 122. The 3D image controller may be, for example, a joystick.

The simulation architecture 10 also comprises a real data access point 117. The use of the real data access point will be described in more detail below.

The simulation architecture 10 as represented in FIG. 1 offers a conventional simulation operation. It supplies real applications 120, 111, 112, 113 with simulated data via the router 107. The simulation architecture 10 according to the invention in this case uses only simulated data.

FIG. 2 represents the simulation architecture 10 according to the invention operating with real data.

When the supervision system is in real operating mode, each application 120, 111, 112, 113 communicates with the equipment 20 that it supervises.

The train control module 120 communicates with real trains 21 via its equipment interface 1211. The train control model can thus know the state and the position on the rail network of the trains and communicate instructions or information to the drivers of the trains.

The station equipment management model 111 communicates notably with access control systems, elevators, escalators, in order to known their states and control their operation.

The video management module 112 communicates notably with surveillance cameras arranged in the station. The video management model can thus know the state of operation of the cameras, drive them remotely and recover the video streams that they record in order to broadcast them to the monitors 116. The images broadcast by the monitors 116 may pass through the supervision infrastructure 110.

The public information module 113 communicates notably with the public information equipment 115. The public information module 113 can thus know the state of operation of the public information equipment 115 and transmit messages to be broadcast to said public information equipment.

In the real operation of the supervision system, the simulation 10 may take into account real data such as the states of the real equipment, for example: the states of the trains 21, the states of the access control systems 22, the states of the elevators and escalators 23, the states of the surveillance cameras 24, possibly the images from the surveillance cameras 24, the states of the public information equipment 115, and the public information messages. Other real data may also be taken into account by the simulation 10.

In real operation, the supervision system may be interfaced with the simulation 10 via the real data access point 117. The real data access point 117 is linked to the supervision infrastructure 110. The supervision infrastructure 110 then transmits, in real time to the simulation 10, the states of the equipment 20 and data originating from the equipment 20. From the real data access point 117, the data are transmitted directly to the models which can use them, such as: the station model 102, the behavioral model 105, the train model 101. Some models simply broadcast the real data concerning the states of the equipment to the synthetic environment infrastructure 106 in the form of simulated data. The states of the real equipment passing through the synthetic environment infrastructure 106 can then be used by other models such as: the 3D infrastructure model 118.

The train model 101 may take into account the real information relating to the trains, for example the positions of the different trains, their speeds, the state of operation of their equipment. The train model 101 then operates in a real mode: it broadcasts, in the form of simulated data, the real data that it has received from the access point 117. In real mode, the train model 101 performs no processing operations other than the broadcasting of the states of the trains.

The station model 102 may take into account the real information concerning the states of the train station equipment such as: the escalators, the elevators, the access control systems. The station model may also take into account real data transmitted by the equipment such as the direction of operation of the escalators, the number of people who have passed through the access control systems. The real data and information are then transmitted by the station model 102 to the synthetic environment infrastructure.

The behavioral model 105 can use real data in order to know the positions and the number of people in the station. From this information, the behavioral model 105 can create entities representing the people moving around in the station. The behavioral model 105 can then broadcast the positions of the entities that it is simulating to the synthetic environment infrastructure 106.

The 3D infrastructure model 118 can recover from the synthetic environment infrastructure 106 the data that will enable it to update the representation of the infrastructure, such as: the positions of the trains, the states of the station equipment. Then, the 3D infrastructure model 118 transmits the updated infrastructure to the 3D image generation model. The 3D infrastructure model 118 operates in real mode in a way substantially equivalent to its operation in simulated mode.

The incident model 104 can recreate, from real data that it receives from the real data access point 117, an incident detected by station sensors. For example, if a fire starts, the incident model can use a fire alarm transmitted by the station equipment management module 111. On receipt of this alarm, the incident model can create a virtual fire which will be represented on the 3D image generated by the 3D image generation model 121. The incident model can also recreate, from data obtained from the smoke detector, the spread of the smoke in the infrastructure. Thus, it is possible to view on the 3D monitor 119 the various fire centers and the smoke-affected areas. This type of information may be particularly useful in organizing a fire service intervention.

The 3D image generation model uses the data originating from the infrastructure model 118, and the entities modeled by the behavioral model in order to generate a realistic three-dimensional image of the real situation. The three-dimensional image generated is then broadcast on a 3D monitor 119. An operator can, via a 3D image controller 122, visually explore the scene by moving around in the 3D image generated. The 3D image generation model has a mode of operation substantially equivalent in real mode to its operation in simulated mode.

The surveillance camera model 103 is inactive in real mode. The router 107 is not connected to the supervision applications 120, 111, 112, 113 in real mode.

FIG. 3 represents an exemplary structure of simulation architecture models 10 according to the invention, suitable for operating in real mode and in simulated mode. The real mode and the simulated mode are two mutually exclusive modes of operation of the simulation 10. The models operate either all in real mode or all in simulated mode.

FIG. 3 shows two models represented for the example. A first model represented in FIG. 3 is called equipment model 30. The equipment model represents the models such as the train model 101, the station model 102. A second model represented in FIG. 3 is the behavioral model 105.

The equipment model 30 comprises an equipment model engine 31 comprising modeling processing functions specific to the model. The equipment model engine 31 notably generates in simulation mode the states of the entities that it is simulating. The states of the entities generated are then transmitted by the equipment model engine 31 to a storage database 32. The storage database 32 then transmits the states of the virtual equipment 34 to a first synthetic environment interface 33. The first synthetic environment interface 33 transfers the states of the virtual equipment 34 to the synthetic environment infrastructure 106 to make them available to the other models. In real mode, the equipment model engine 31 is inactive. The states of the virtual equipment are not transmitted to the storage database 32. In real mode, the equipment model can receive states of the real equipment originating from the real data access point 117. The real equipment data arrive in the equipment model 30 via a first real data access point interface 43. The first real data access point interface 43 transmits the real equipment states 35 that it has received in the same format as the virtual equipment states 34 transmitted by the equipment model engine 31 to the storage database 32. Then, the storage database 32 transmits, as in the simulated mode, the real equipment states 35 in the form of virtual equipment states 34 to the first interface with the synthetic environment infrastructure 33. The real equipment states 35, formatted like virtual equipment states 34, are made available to the simulation models on the synthetic environment infrastructure 106.

The behavioral model 105 comprises a behavioral model engine 36 simulating entities. The simulated entities are people animated according to a motivational model. The behavioral model engine 36 notably supplies the positions of the simulated people, possibly their movement (type and direction), to a second synthetic environment infrastructure interface 37. The second synthetic environment infrastructure interface 37 transmits the states and other information concerning the simulated entities 38 to the synthetic environment infrastructure 106. The synthetic environment infrastructure 106 makes the states of the simulated entities available to the other models. For example, the 3D image generation model 121 uses this information in order to display, in the 3D image that it generates, the people potentially present in the infrastructure. The behavioral model can be configured so as to generate a certain number of entities in determined places, for example. To this end, the behavioral model engine 36 can take into account a configuration of the behavioral model 39 for example in the form of a configuration database. In the simulated mode, the configuration database may be filled out before the start of a simulation session. The configuration database may, for example, include different configurations evolving over time. Thus, the behavioral model engine may, for example, cyclically interrogate the configuration database to load a current configuration.

In the real mode, the behavioral model can take into account real data 40. The real data 40 originate from the real data access point 117 and reach the behavioral model 105 via a second real data access point interface 41. The second real data access point interface 41 transmits the real data received to a first real data interpretation module 42. The first real data interpretation module 42 deduces, from the real data 40, the number, the potential positions of the various people present in the infrastructure. The real data 40 received may be of different types and originate from different equipment of the infrastructure. For example, the real data 40 may be the number of people entering and leaving the station at a given instant, video images making it possible to deduce the number of people occupying a certain space, motion sensors, the weight of a train entering into the station, making it possible to determine the number of people inside the train. An analysis of the movements of the people in successive video images over time of one and the same space may make it possible to deduce the directions and the speeds of movement of the people. With the positions of the people, their direction and their movement, it is possible to predict their future positions. Thus, the first real data interpretation module 42 may make it possible to deduce the number of people in a given space without necessarily having the real data. For example, it is possible to predict the occupancy of a space that does not have any video surveillance cameras. The first real data interpretation module 42 makes it possible to reproduce a situation that is realistic from the point of view of the occupancy of spaces by people.

The incident model 104 may include, like the behavioral model 105, a third real data access point interface, a second real data interpretation module, an incident model configuration module, an incident model engine, a third interface with the synthetic environment infrastructure.

The data obtained from the behavioral model 105 and possibly from the incident model 104 are then taken into account to generate a synthetic 3D image which can therefore represent spaces for which the supervision system itself has little or no information.

FIG. 4 represents a general principle of the invention. Schematically, a situation in the infrastructure can be described by a set of data 400. The data describing the situation 400 may consist of real data 401 comprising states of the equipment of the infrastructure, data from sensors forming part of the infrastructure such as cameras, smoke detectors. The data describing the situation 400 may also include data that cannot be transmitted 402 to the supervision system 11. Certain data describing the situation may not be able to be transmitted, for example, for lack of sensors for detecting them, or because they simply cannot be described. The real data are transmitted by the equipment 20 to the supervision system 11. Then, the real data 401 are transmitted to the simulation 10. The simulation 10 analyzes the real data to recreate data describing the situation 404 that are as close as possible to the real situation data 400. The recreated data 404 are the synthetic data describing the situation. To this end, the simulation models analyze the real data 401 to generate virtual data 403. The virtual data complement the real data 401 with virtual data 403 modeling the non-transmissible data 402. The simulation therefore produces synthetic data describing the situation 404 modeling the real situation data 400. The synthetic data describing the situation 404 can be used to generate a realistic representation in 3D images of a real situation in the infrastructure.

The present invention can be applied to any type of infrastructure supervision system. The invention can likewise replace an interface of the supervision system by providing the supervision operator with a view that can easily be projected into a drawing by orienting the view as a view from above for example.

The three-dimensional image generated can also be projected by holographic projection systems.

The invention has the notable advantage of providing a three-dimensional representation of a situation without having video surveillance cameras supplying visual information.

Another advantage of the application is to be able to replace certain cameras with less costly and more robust sensors such as motion sensors.

Another advantage of the invention is that it makes it possible to obtain a three-dimensional view of a situation in a space where it is impossible to place a camera or other sensors, for example because of environmental conditions such as a temperature that is too high to allow a camera to operate normally.

The invention also makes it possible to view a situation in a space where the sensors have failed or for which the data is unusable because of an incident such as an emission of smoke which may obscure an image supplied by a video surveillance camera.

Advantageously, the invention makes it possible to present a realistic and easily interpretable view of an infrastructure. Furthermore, it is possible to choose the angle, the position of the view by moving around in the three-dimensional image.

The invention advantageously makes it possible, in an emergency situation, to have a synthetic and rapidly interpretable overview of the situation in the infrastructure.

1. A simulation device for simulating an environment of an infrastructure supervision system, said supervision system comprising;
one or more applications for supervising real equipment of the infrastructure;
a common supervision infrastructure to which the supervision applications are connected; and
a model for generating representations in three dimensions of a situation in the infrastructure on the basis of real data, said real data originating from the real equipment supervised by the supervision system via an interface between the common supervision infrastructure and the simulation device, said real data being complemented with virtual data originating from simulation models, said virtual data being deduced by the simulation models from the real data originating directly from the common supervision infrastructure, said virtual data modeling description data concerning the situation in the infrastructure, not transmitted by the supervised real equipment.

2. The simulation device according to claim 1, further comprising first models simulating equipment of the infrastructure, said first models having an operation in real mode during which the data originating from the real equipment are transformed into simulated data then broadcast to the other simulation models via a synthetic environment infrastructure.

3. The simulation device according to claim 2, wherein the first models comprise an equipment simulation engine generating simulated data, said simulation engine being inactive in a real mode.

4. The simulation device according to claim 1, further comprising second simulation models simulating virtual entities, said second models operating in real mode during which they interpret the real data received to model virtual entities.

5. The simulation device according to claim 2, wherein the model for generating representations in three dimensions generates images in three dimensions on the basis of data from a description model of the infrastructure in three dimensions and data originating from the real equipment broadcast via the synthetic environment infrastructure.

6. The simulation device according to claim 5, wherein the description model of the infrastructure in three dimensions is updated on the basis of the real data originating from the real equipment (20), that it recovers via the synthetic environment infrastructure.

7. The simulation device according to claim 2, further comprising a behavioral model simulating people occupying the infrastructure, said behavioral model interpreting the real data to deduce therefrom a number and positions of the simulated people occupying the infrastructure, the virtual data corresponding to the simulated people being broadcast via the synthetic environment infrastructure.

8. The simulation device in according to claim 7, wherein the model for generating representations in three dimensions generates images in three dimensions comprising the people simulated by the behavioral model.

9. The simulation device according to claims 2, further comprising an incident model simulating incidents in the infrastructure, said incident model interpreting the real data to detect an incident in the infrastructure and to simulate the detected incident, the data concerning the simulated incident being broadcast via the synthetic environment infrastructure.

10. The simulation device according to claim 9, wherein the model for generating representations in three dimensions generates images in three dimensions comprising the simulated incidents.

11. The simulation device according to claim 1, wherein the model of representations in three dimensions (121) generates images according to a position and a viewing angle chosen by an operator by means of a three-dimensional image controller (122), said three-dimensional image controller (122) transmitting the position and the viewing angle chosen by the operator to the model for generating representations in three dimensions (121) which recomputes the images in three dimensions on the basis of the chosen position and viewing angle.
